(19) United States
(12) Patent Application Publication
(10) Pub. No.: US 2016/0024689 A1
(43) Pub. Date: Jan. 28, 2016

(54) METHOD AND DEVICE FOR DETERMINING ONE OR MORE ENZYMES FOR BIOCHEMICAL TRANSFORMATION

(71) Applicant: Samsung Electronics Co., Ltd., Suwon-si (JP)

(72) Inventors: Saswati DANA, Bangalore (IN); Anirban BHADURI, Bangalore (IN); Venkata Tadi SIVA KUMAR, Andhra Pradesh (IN); Varun GIRI, Delhi (IN); Kyusang LEE, Ulsan (KR); Taeyong KIM, Yongin-si (KR)

(21) Appl. No.: 14/805,783

(22) Filed: Jul. 22, 2015

(30) Foreign Application Priority Data
Jul. 23, 2014 (IN) 3606/CHE/2014
Dec. 4, 2014 (KR) 10-2014-0173233
Jan. 26, 2015 (KR) 10-2015-0012314

(51) Int. Cl. C40B 30/02; G06F 19/16

(52) U.S. Cl. CPC C40B 30/02; G06F 19/16

(57) ABSTRACT

Systems and methods for identifying enzymes for catalysing biochemical reactions include receiving input of reaction(s) and/or target molecule(s) along with data associated with chemical conversion, determining functional and linker region(s) in the input, scanning a transformation library for the determined functional region(s) of the reaction(s) and/or the target molecule(s) to find similar functional region(s) within the transformation library, assigning the reaction(s) and/or target molecule(s) to group(s) of the transformation library showing a high similarity to the transformation, computing a metabolite similarity score of the reaction(s) and/or target molecule(s) with respect to one or more reactions of the assigned group, and identifying enzyme(s) associated with the reaction(s) of the assigned group having a high metabolite similarity score. A transformation library is also generated.

### BACKGROUND

1. Field

The present disclosure relates to selection of enzymes for catalysing biochemical reactions, and more particularly to devices and methods for identifying enzymes for biochemical transformations.

2. Description of Related Art

Advances in metabolic and recombinant genetic engineering have facilitated novel synthetic pathways design. These developments have facilitated biosynthesis of chemicals. Industrially scalable organisms can be optimally designed for biosynthesis of molecules. Often, a proposed synthetic pathway comprises non-native molecules (not naturally observed in considered models system). Biological transformation of non-native molecules is challenging, as it requires selection and engineering of appropriate enzymes to improve thermodynamic and kinetic properties for industrial application. Given their structure and flexibility, individual enzymes are amenable to a degree of adaptation. This impacts efficiency of a process and thus the selection of appropriate enzymes are critical.

Favourability of an enzyme to perform a biochemical reaction is dependent on the enzyme's binding properties towards a given target molecule. Enzyme-target molecule binding is traditionally assessed through a 3-dimensional docking/molecular dynamics study. Application of the approach is computationally intensive and is thus not preferred for screening a large enzyme dataset. A “quantitative structure activity relationship” (QSAR) methodology can also be applied for selecting enzymes. Though rapid in processing, accuracy of the QSAR approach depends on the quality of the prediction model. To enhance the model performance, a well-represented training data set is needed. Thus, obtaining stable QSAR models for a diverse set of Enzyme Commission (EC) numbers is challenging.

Alternatively, a reaction similarity approach can be used for large-scale data size. Unfortunately, these approaches, though efficient, are limited in their accuracy.

Therefore, there is a need for a method to select and identify potential enzymes for biochemical transformation which is efficient as well as accurate.

### SUMMARY

The present disclosure provides methods and devices for determining one or more enzymes for biochemical transformations.

An embodiment of the present disclosure provides a computer implemented method of determining enzyme(s) for biochemical transformation(s). The method steps include receiving input of reaction(s) and/or target molecule(s) along with data associated with information regarding chemical conversion; determining functional region(s) and linker region(s) in the reaction(s) and/or the target molecule(s); scanning a transformation library for the determined functional region(s) to find similar functional region(s) within the transformation library; assigning the reaction(s) and/or the target molecule(s) to group(s) of the transformation library showing a high similarity of the functional region(s); computing a metabolite similarity score of the reaction(s) and/or the target molecule(s) with respect to reaction(s) of the assigned group(s); and identifying enzyme(s) associated with the reaction(s) of the assigned group(s) having a high metabolite similarity score.

Another embodiment of the present disclosure provides a computer implemented method of determining enzyme(s) for biochemical transformation(s) further includes statistically evaluating flexibility of the identified enzyme(s) for the input of the reaction(s) and/or the target molecule(s).

Another embodiment of the present disclosure provides a device for determining enzyme(s) for biochemical transformation(s). The device includes memory; and processor(s) operatively coupled to the memory. The processor(s) is/are configured to perform the steps of receiving input of reaction(s) or/and target molecule(s) along with data associated with their chemical conversion; determining functional region(s) in the reaction(s) or/and the target molecule(s); scanning a transformation library for the determined functional region(s) to find similar functional region(s) within the transformation library; assigning the reaction(s) or/and the target molecule(s) to group(s) of the transformation library showing a high similarity of the functional region(s); computing a metabolite similarity score of the reaction(s) or/and the target molecule(s) with respect to reaction(s) of the assigned group(s); and identifying enzyme(s) associated with the reaction(s) of the assigned group(s) having a high metabolite similarity score.

Another embodiment of the present disclosure provides a computer implemented method of generating a transformation library. The method steps include obtaining a plurality of reactions and enzyme(s) catalysing the same from knowledgebase as input; identifying transformation region(s) in molecule(s) participating in the plurality of reactions; extracting the identified transformation region(s) in the molecule(s) participating in the plurality of reactions; identifying functional region(s) and linker region(s) for each of the molecule(s) participating in the plurality of reactions based on the extracted transformation region(s); collecting the identified functional region(s) and associated linker region(s) of the molecule(s) participating in the plurality of reactions; selecting the functional region(s) of the plurality of reactions, wherein the functional regions comprise the collected functional regions of the molecule(s) participating in the plurality of reactions; selecting linker region(s) of the plurality of reactions, wherein the linker region(s) comprise the collected linker region(s) of the molecule(s) participating in the plurality of reactions; grouping the plurality of reactions based on similarity of the functional region(s) along with associated information together to create the transformation library; and identifying functional region(s) for each group from the functional region(s) of the reaction(s) comprising the group as representative functional region(s).

Yet another embodiment of the present disclosure provides a device for generating transformation library. The device includes memory; and processor(s) operatively coupled to the memory, the processor(s) is/are configured to perform the steps of obtaining a plurality of reactions and enzyme(s) catalysing the same from biochemical database(s) as input; identifying transformation region(s) in molecule(s) participating in the plurality of reactions; extracting the identified transformation region(s) in the molecule(s) participating in the plurality of reactions; identifying functional region(s) and linker region(s) for each of the molecule(s) participating in the plurality of reactions based on the extracted transformation region(s); collecting the identified functional region(s) and associated linker region(s) of the molecule(s) participating in the plurality of reactions; selecting the functional region(s) of the plurality of reactions, wherein the functional regions comprise the collected functional regions of the molecule(s) participating in the plurality of reactions; selecting linker region(s) of the plurality of reactions, wherein the linker region(s) comprise the collected linker region(s) of the molecule(s) participating in the plurality of reactions; grouping the plurality of reactions based on similarity of the functional region(s) along with associated information together to create the transformation library; and identifying functional region(s) for each group from the functional region(s) of the reaction(s) comprising the group as representative functional region(s).

### BRIEF DESCRIPTION OF THE DRAWINGS

The aforementioned aspects and other features of the present disclosure will be explained in the following description, taken in conjunction with the accompanying drawings, wherein:

FIG. 1 is a flow diagram depicting a method of determining one or more enzymes for a biochemical transformation represented as reactions and/or target molecules along with their associated chemical conversion, according to one embodiment.

FIG. 2 is a flow diagram depicting steps involved in identifying one or more functional regions and one or more linker regions associated with the one or more functional regions in the one or more molecules participating in the reaction, according to one embodiment.

FIG. 3 is a flow diagram depicting steps involved in determining the one or more functional regions and one or more linker regions in the one or more input reactions, according to one embodiment.

FIG. 4 is a flow diagram depicting steps involved in identifying one or more functional regions and one or more linker regions in the one or more target molecules, according to one embodiment.

FIG. 5 is a schematic representation depicting identification of functional and linker region in a given input, according to one embodiment.

FIG. 6 is flow diagram depicting a method of computing metabolite similarity score for one or more inputs, according to one embodiment.

FIG. 7 is a flow diagram depicting a method of determining one or more enzymes, along with its flexibility and specificity, for a biochemical transformation, according to one embodiment.

FIG. 8 is a block level diagram of a device for determining one or more enzymes for one or more biochemical transformations, according one embodiment.

FIG. 9 is flow diagram steps involved in generating transformation library, according to one embodiment.

FIG. 10 is a schematic representation depicting an exemplary transformation grouping and transformation library creation, according to one embodiment.

FIG. 11 is a block level diagram of a device for generating transformation library, according one embodiment.

The drawings described herein are for illustration purposes only and are not intended to limit the scope of the present disclosure in any way.

### DETAILED DESCRIPTION

The embodiments of the present disclosure will now be described in detail with reference to the accompanying drawings. However, the present disclosure is not limited to the embodiments. The present disclosure can be modified in various forms. Thus, the embodiments of the present disclosure are only provided to explain more clearly the present disclosure to the ordinarily skilled in the art of the present disclosure. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Screening and selecting enzymes for synthetic biochemical reactions is challenging. The present disclosure provides for method and device of determining one or more enzymes for biochemical transformation.

The term “similarity” in the context of the present disclosure is referred to as chemical similarity or any other equivalent such as, but not limited to, similarity based on structure, functional groups, function, chemical/physical characteristics, etc.

Prediction of Enzymes for Reaction(s) and/or Target Molecules

Screening and selecting enzymes for synthetic biochemical reactions is challenging. The present disclosure provides for methods and devices for determining one or more enzymes for biochemical transformation.

The present disclosure provides embodiments that advantageously predict enzyme(s) for a given biochemical transformation. The prediction is made with respect to inputs, which could include data about reaction(s) and/or target molecule(s) along with information pertaining to their chemical conversion. These inputs are analysed to determine functional region(s) and linker region(s). The determined functional region(s) and linker region(s) are used to evaluate similarity against reactions in a transformation library and to identify the enzyme(s).

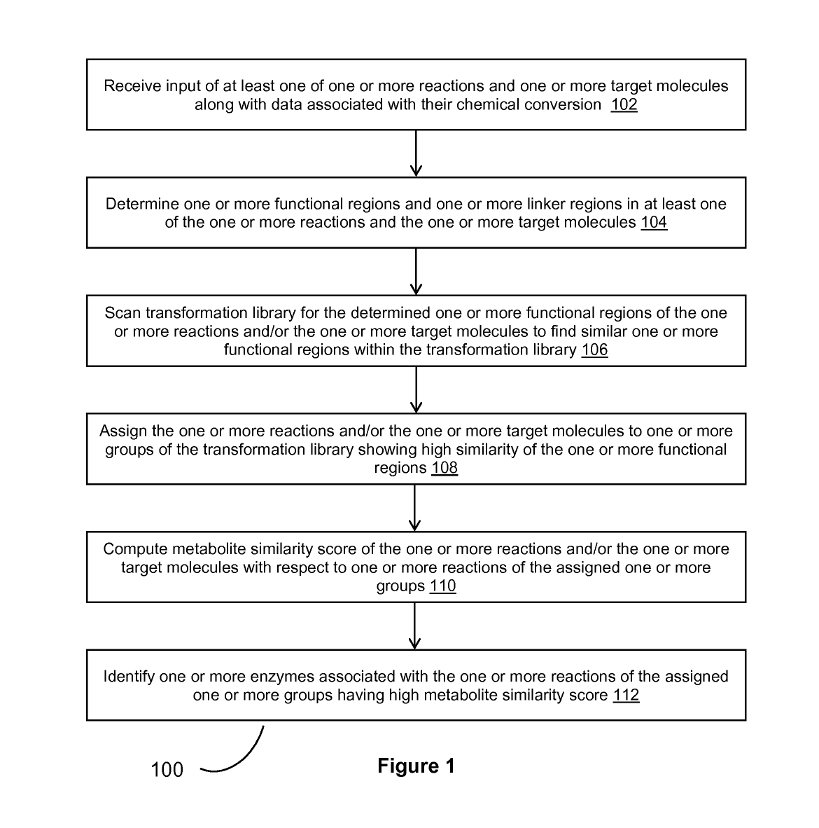

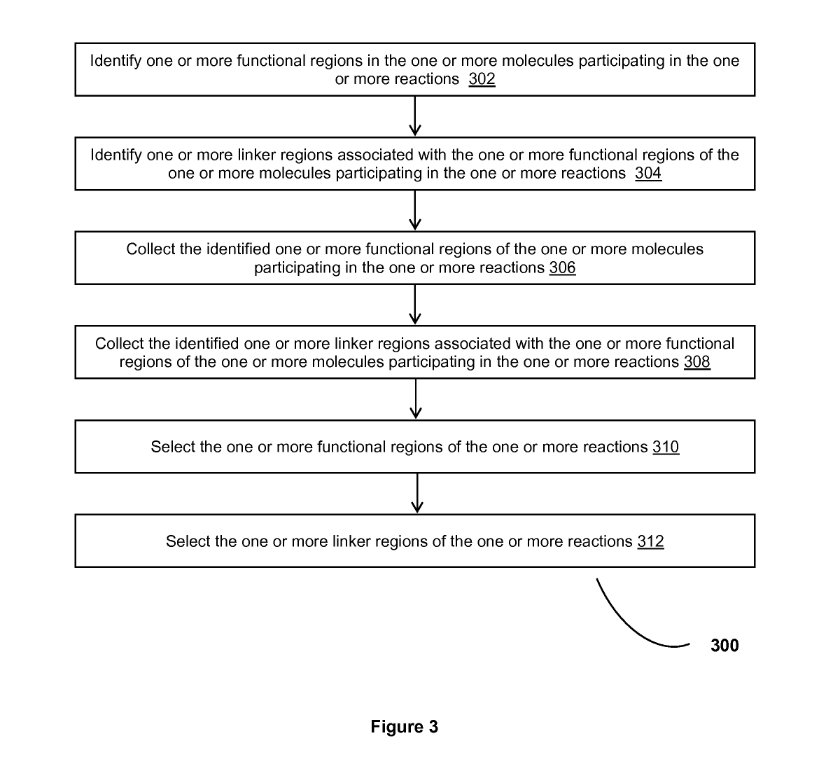

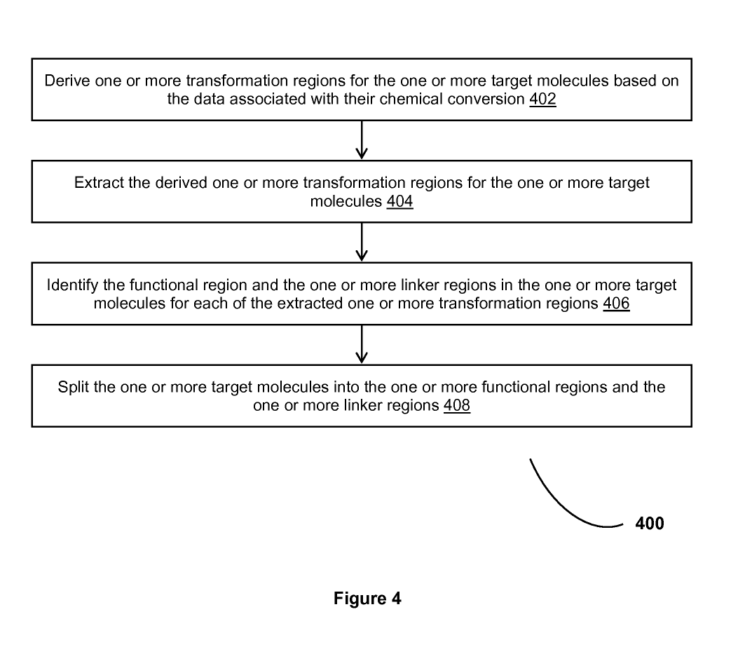

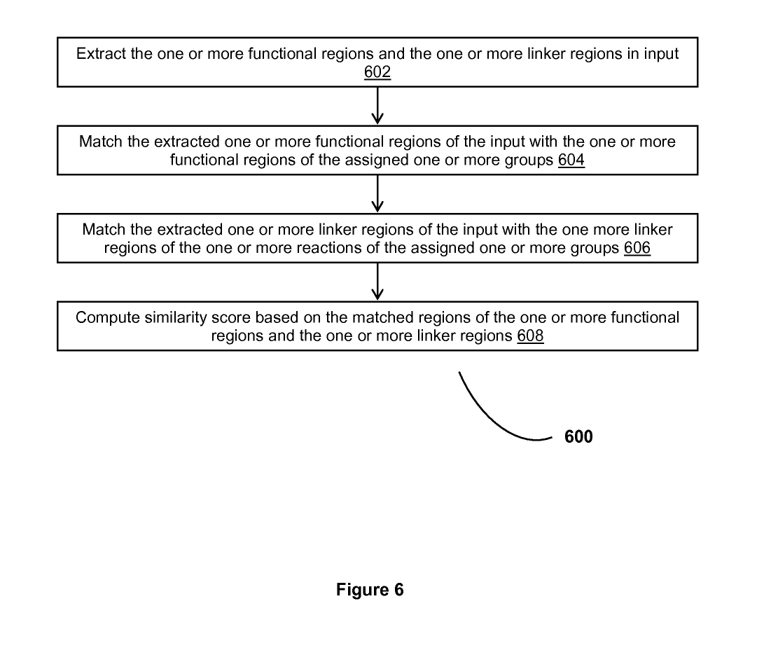

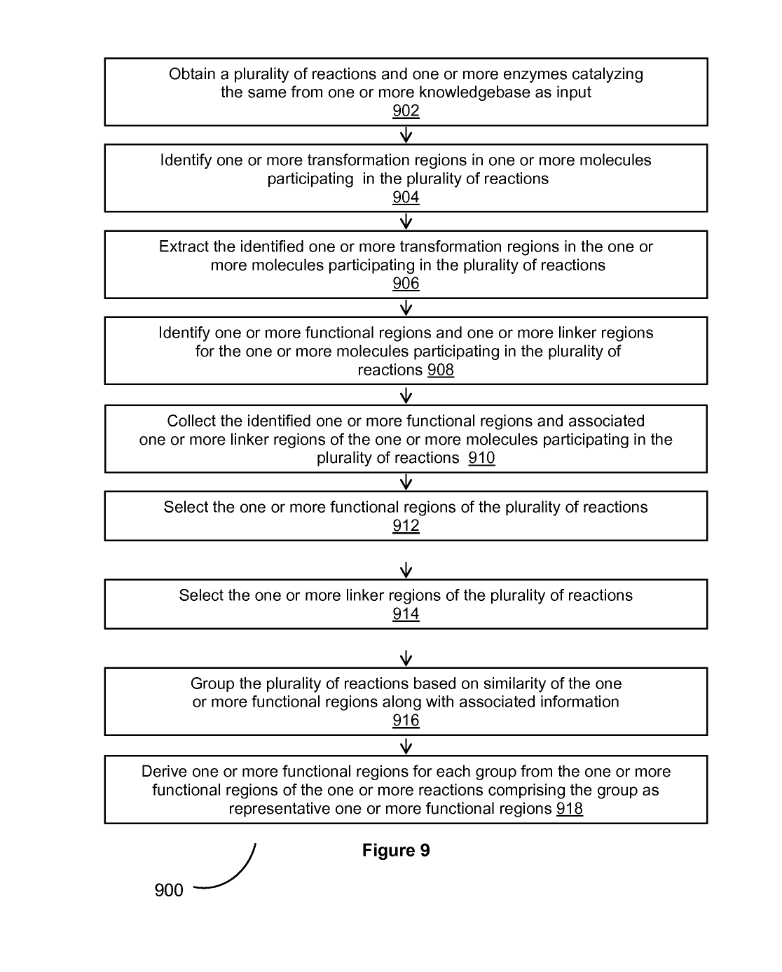

The flow diagram as given in FIG. 1 provides detailed steps of the present method, according to one embodiment. All the method steps are performed by a computing device, e.g., including a processor. The reaction(s) and/or target molecule(s) along with data pertaining to their chemical conversion or combination thereof for which appropriate enzyme(s) are to be selected are received as the input(s) at step 102. The target molecule can be a reactant and/or a product. The chemical conversion information comprises at least one of transformation region information and reaction conversion information (e.g., attributes governing the transformation). The input(s) are processed to determine functional region(s) and linker region(s) at step 104. Depending on the input, i.e., reaction or target molecule, the present disclosure provides for different embodiments (FIGS. 3 and 4). Subsequently, a transformation library (containing a list of reactions decomposed into functional and linker region(s) and corresponding enzymes) is scanned for the determined functional region(s) of the input(s) to find similar functional region(s) within the transformation library at step 106. One method for generating the transformation library is detailed later in FIG. 9. The functional region(s) identified for the input(s) is/are matched up with the functional region(s) associated with each of the groups of the transformation library. The input(s) are assigned to group(s) of the transformation library showing a high similarity of the functional region(s) at step 108. The input reaction(s) and/or target molecule(s) can be assigned to different groups of the transformation library based on the similarity of functional regions. An identified group is also referred to as an assigned group. At this stage the vast number of known reactions is narrowed down to the reaction(s) comprising the assigned group(s) of the transformation library. Subsequently, metabolite similarity score(s) of the input(s) with respect to reaction(s) of the assigned group(s) is/are computed at step 110. The steps involved in computing a metabolite similarity score is elaborated in FIG. 6. Finally the enzyme(s) associated with the reaction(s) of the assigned group(s) having high metabolite similarity score(s) with respect to the input(s) is/are identified at step 112. An identified enzyme is selected as a candidate for the biochemical transformation in the input(s).

Identification of Functional Reqion(s) and Linker Reqion(s) of the Input(s) (Step 104):

(A) When Reaction(s) is/are Input

Determination of functional region(s) for the input reaction starts with identification of transformation region(s) in the molecule(s). Based on the identified transformation region(s), functional and linker regions are identified.

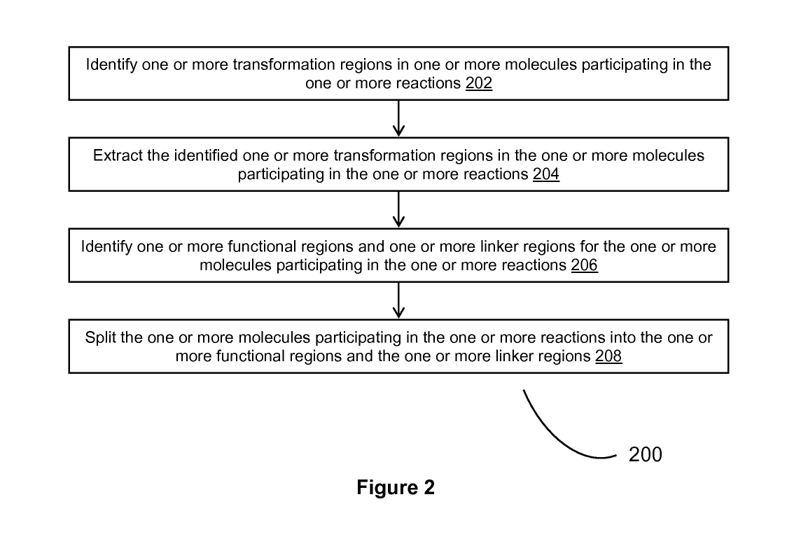

FIG. 2 is a flow diagram depicting steps involved in identifying functional region(s) and linker region(s) in the molecule(s) participating in the reaction, according to one embodiment. A molecule can be either a reactant or a product of the input reaction. The transformation region(s) in the molecule(s) participating in the reaction(s) is/are identified at step 202. The transformation region(s) of the reactant molecule (product molecule) is/are identified by comparing it to corresponding product molecule(s) (reactant molecule(s)). The identified transformation region(s) is/are extracted at step 204. The functional region(s) and the associated linker region(s) for the molecule(s) participating in the reaction(s) is/are next identified at step 206. The functional region(s) for a molecule comprises either its identified transformation region(s) or the transformation region(s) and region(s) of interest. The region of interest comprises one of an immediate neighbourhood and an extended neighbourhood of the transformation region(s). The linker region(s) for a molecule is the residual region of the molecule after selection of the functional region(s). The molecule(s) participating in the reaction(s) is/are split into the functional region(s) and the linker region(s) at step 208.

FIG. 3 is a flow diagram depicting steps involved in determining the functional region(s) and linker region(s) in the input reaction(s), according to one embodiment. The functional region(s) in the molecule(s) participating in the reaction(s) is/are identified at step 302. Further at step 304, the linker region(s) associated with the functional region(s) of the molecule(s) participating in the reaction(s) is/are identified. The steps 302 and 304 for identification of functional region(s) and linker region(s) in the input reaction(s) are elaborated previously in FIG. 2. The identified functional region(s) of molecule(s) participating in the reaction(s) are collected at step 306. The identified linker region(s) associated with the functional region(s) of the molecule(s) participating in the reaction(s) are collected at step 308. The functional region(s) of the reaction(s) are selected, wherein the functional region(s) comprise the collected functional region(s) of the molecule(s) participating in the reaction(s), at step 310. The functional region(s) of the reaction(s) is/are derived from the functional region(s) of one or more selected molecules participating in the reaction(s). Here, the selection is done for the purposes of scanning a transformation library and performing a similarity assessment based on the functional region(s) as described in later stages. The linker region(s) of the reaction(s) is/are selected, wherein the linker region(s) comprise the collected linker region(s) of the molecule(s) undergoing transformation in the reaction(s) at step 312. The linker region(s) of the reaction(s) comprises of the linker region(s) associated with the selected functional region(s). The linker region(s) along with functional region(s) are used to compute a metabolite similarity score as described in later stages.

(B) When Target Molecule(s) is/are Input

FIG. 4 is flow diagram depicting steps involved in determining functional region(s) and linker region(s) in the target molecule(s), according to one embodiment. A target molecule can have more than one functional region based on the chemical conversion information. Transformation region(s) for the target molecule(s) is/are derived from the data associated with their chemical conversion at step 402. The derived transformation region(s) for the target molecule(s) is/are extracted at step 404. The functional region(s) and the linker region(s) in the target molecule(s) for each of the extracted transformation region(s) is/are extracted at step 406. The target molecule(s) is/are split into the functional region(s) and the linker region(s) based on the identified functional region(s) and the linker region(s) at step 408.

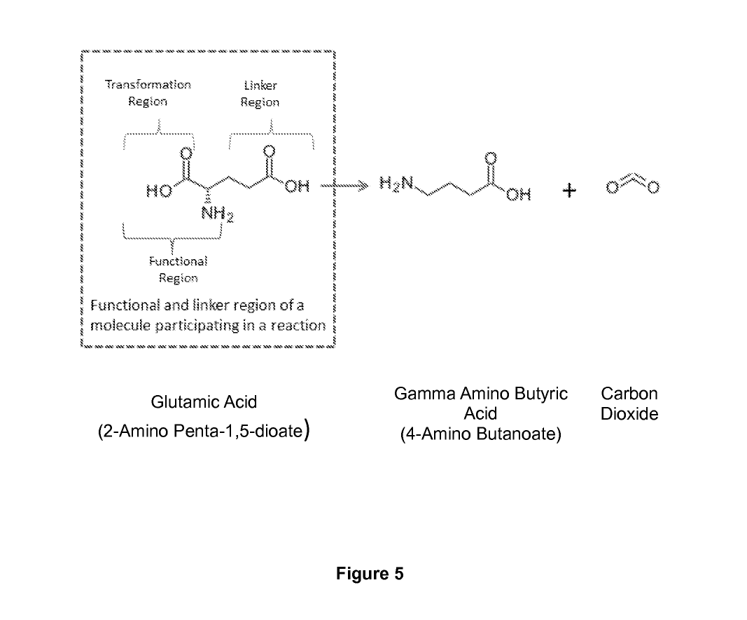

FIG. 5 is exemplary embodiment depicting the identification of a transformation region and subsequent determination of functional and linker regions based thereon. In the given reaction, glutamic acid (2-Amino Penta-1,5-dioate) is converted to gamma amino butyric acid (4-Amino Butanoate) and carbon dioxide. The carboxyl group (—COOH) of amino butyric acid is cleaved during the reaction. It is evident that the carboxyl group is the region of the molecule participating in the reaction and undergoing change, and hence is considered as a transformation region. Further, the C—NH₂ group adjacent to —COOH is necessary for transformation even though not undergoing transformation during the reaction and hence forms the region of interest. Therefore, the transformation region along with the region of interest is considered as a functional region, while the residual region of the molecule forms the linker region.

Computation of Metabolite Similarity Score (Step 110):

FIG. 6 is flow diagram depicting a method of computing a metabolite similarity score for the input(s) (i.e., reaction(s) and/or target molecules(s)), according to one embodiment. The functional region(s) and the linker region(s) in the input(s) are extracted at step 602. The extracted functional region(s) are matched with the functional region(s) of the assigned group(s) at step 604. The extracted linker region(s) for the input(s) are matched with the linker region(s) of the reaction(s) of the assigned group(s) at step 606. Finally, similarity based on the matched functional region(s) and the linker region(s) is/are evaluated and similarity score(s) is/are computed at step 608. The similarity of the matched regions is termed a metabolite similarity and the score obtained is called a metabolite similarity score. The enzyme(s) catalysing the specific reaction(s) of the assigned group(s) which reports a high metabolic similarity score is/are selected as likely candidate(s).

In one of the embodiments for an input molecule, the molecule is represented as a function of two components, the functional region(s) and the linker region(s), given by

A=f(α,β) (1)

where,
A: Input molecule
α: Functional region(s) of input molecule
β: Linker region(s) of input molecule

Under this specific implementation, a metabolite similarity (MS) score between an input molecule A and a representative reaction within a group in transformation library is defined by

$$MS = \frac{{a}_{1} T ( {A}_{α} , α ) + {a}_{2} T ( {A}_{β} , β )}{{a}_{1} + {a}_{2}} \qquad ( 2 )$$

where,
A_{α}: Functional region(s) of molecule A
A_{β}: Linker region(s) of molecule A
α: Representative functional region(s) of a group in the transformation library
β: Linker region(s) of a reaction in the group
T(A_{α}, α): Chemical similarity (Tanimoto coefficient) of functional region(s) of compound A and representative functional region(s) of the group
T(A_{β}, β): Chemical similarity (Tanimoto coefficient) of linker region(s) of compound A and linker region(s) of a reaction in the group
a₁, a₂: Weighting factor for functional and linker regions

This embodiment uses Tanimoto-coefficient-based similarity. Further, similarity could be assessed or determined through other equivalent metrics such as, but not limited to, root mean square deviation, equivalence overlap, etc., for structural similarity; dice, cosine, etc., for chemical similarity; feature based; etc.

Statistically Evaluating of Flexibility of the Identified Eenzyme(s)

The present disclosure also provides for statistically evaluating flexibility of the identified one or more enzymes for the input(s). Once the enzyme(s) from the list of enzymes associated with the assigned group having high metabolite similarity score(s) are identified, the flexibility of the identified enzyme(s) is evaluated by a statistical approach such as, but not limited to, Z-score, variation, dispersion, etc. Additionally, flexibility can be assessed through structural flexibility of the enzyme structure(s) through root mean square variation at each residual point.

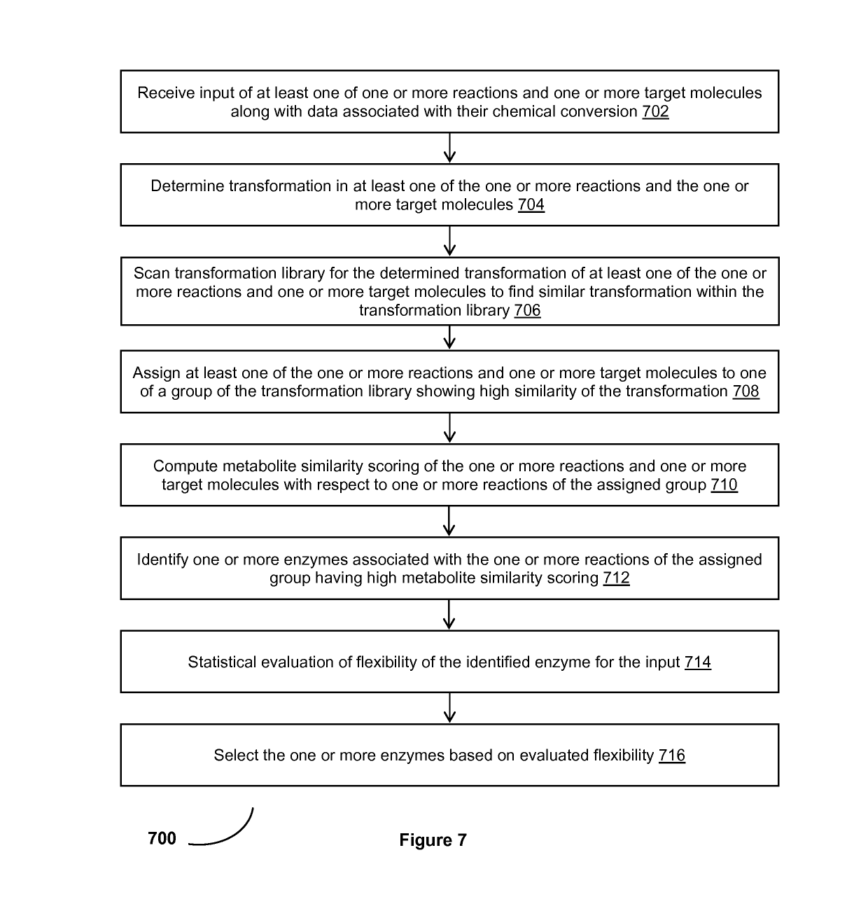

An embodiment is illustrated in FIG. 7 which is a flow diagram depicting a method of determining enzyme(s) for biochemical transformation, while statistically evaluating flexibility of the identified enzyme(s). Steps 702 to 712 are performed in the same manner as the steps 102 to 112 of FIG. 1. The flexibility of the identified enzyme(s) for the input(s) is/are statistically evaluated at step 714. Flexibility of an enzyme is its capability to catalyse diverse substrates. Flexibility is assessed based on, but not limited to, structure of enzyme, physio-chemical properties of enzyme and diversity of substrates (structural, chemical and physical properties). Based on the premise that the catalysis is dependent upon the enzyme's ability to bind to substrates, the capability of the enzyme to adapt to a new substrate can be studied through flexibility. Thus, along with the metabolite similarity score the statistical assessment estimates prediction reliability. Based on evaluated flexibility, identified enzyme(s) are further selected at step 716.

In one of the embodiments, a functional similarity index (ξ) is used for assessing flexibility of the enzymes. The functional similarity index is computed using Z-score.

Functional Similarity Index (FSI) ξ is represented as given below:

$${ζ}_{AB} = \frac{MS - μ}{σ} \qquad ( 3 )$$

where:
MS: defined by equation (2)
μ: Mean of metabolite similarity for native substrate of a given enzyme
σ: Standard deviation of metabolite similarity for substrate of a given enzyme

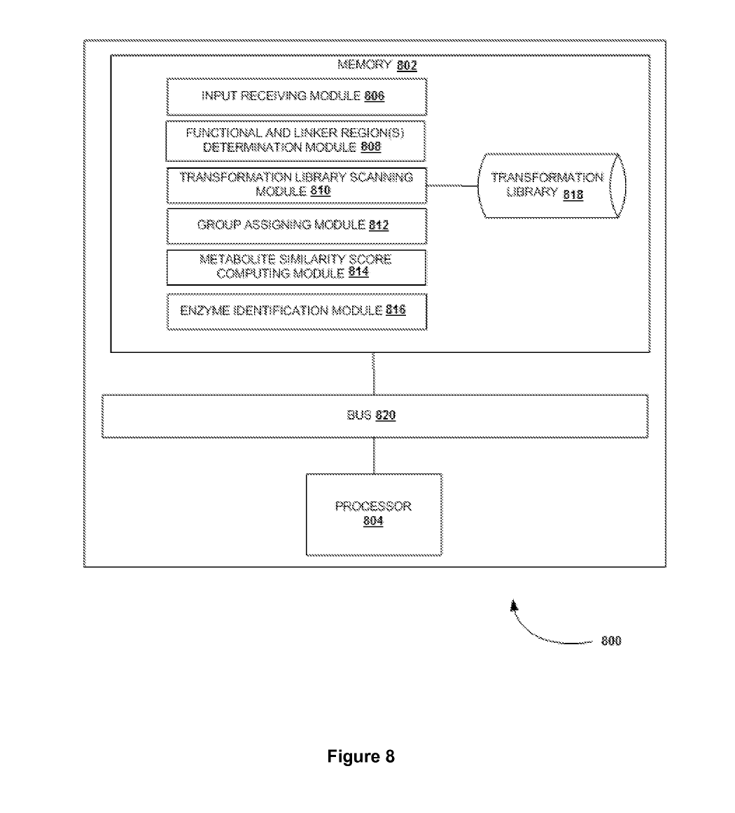

The present disclosure also provides for a device for determining enzyme(s) for biochemical transformation. FIG. 8 is a block level diagram of a device for determining enzyme(s) for biochemical transformation(s) in accordance with an exemplary embodiment of the present disclosure. The device is configured to determine suitable enzymes for input, which can be reaction(s) and/or target molecule(s) along with data associated with its chemical conversion. The device 800 includes processor(s) 804, and memory 802 coupled to the processor(s) 804.

The processor(s) 804, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 802 includes a plurality of modules stored in the form of executable program code which instructs the processor(s) 804 to perform the method steps illustrated in FIG. 1. In one embodiment, the memory 802 includes the following modules: input receiving module 806, functional and linker region(s) determination module 808, transformation library scanning module 810, group assigning module 812, metabolite similarity score computing module 814, and enzyme identification module 816. Memory 802 also stores transformation library 818. Computer memory elements may include any suitable memory device(s) for storing data and executable program, such as read only memory (ROM), random access memory (RAM), erasable programmable read only memory (EPROM), electrically erasable programmable read only memory (EEPROM), a hard drive, a removable media drive, e.g., for handling memory cards, and the like. Embodiments of the present disclosure may be implemented in conjunction with program modules, including functions, procedures, data structures, and application programs, for performing tasks, or defining abstract data types or low-level hardware contexts. Executable program stored on any of the above-mentioned storage media may be executable by the processor(s) 804.

The input receiving module 806 instructs the processor(s) 804 to perform the step 102 (FIG. 1).

The functional and linker region(s) determination module 808 instructs the processor(s) 804 to perform the step 104 (FIG. 1).

The transformation library scanning module 810 instructs the processor(s) 804 to perform the step 106 (FIG. 1) by scanning the transformation library 818 stored in the memory 802. In an alternative embodiment, the device is communicatively coupled to a back-end server (not shown in the figure), where the back-end server stores the transformation library 818.

The group assigning module 812 instructs the processor(s) 804 to perform the step 108 (FIG. 1).

The metabolite similarity score computing module 814 instructs the processor(s) 804 to perform the step 110 (FIG. 1).

The enzyme identification module 816 instructs the processor(s) 804 to perform the step 112 (FIG. 1).

In another embodiment, the processor(s) 804 is further configured to statistically evaluate flexibility of the identified one or more enzymes for the input of the reaction(s) and/or target molecule(s) by performing the step 714 (FIG. 7). The memory 802 in this embodiment includes the following modules: input receiving module 806, functional and linker region(s) determination module 808, transformation library scanning module 810, group assigning module 812, metabolite similarity score computing module 814, enzyme identification module 816, and flexibility assessment module 822 (not shown in the FIG. 8).

The flexibility evaluation module 822 instructs the processor(s) 804 to perform the step 714 (FIG. 7).

Transformation Library

The present disclosure also provides for a method and device for generating the transformation library.

FIG. 9 is flow diagram of steps involved in generating a transformation library, according to one embodiment. The transformation library is generated by grouping similar reactions, thereby covering collection of reported bio-molecular conversions. The present disclosure groups input reactions based on the functional region(s) similarity and conservation chemistry. All the method steps for generating transformation library are performed by a computing device.

Various reactions with their respective catalysing enzymes from various knowledgebases as input are obtained at step 902. Transformation region(s) in molecule(s) participating in the plurality of reactions is/are identified at step 904. The identified transformation region(s) in the molecule(s) participating in the plurality of reactions are extracted at step 906. Functional region(s) and linker region(s) for the molecule(s) participating in the plurality of reactions based on the extracted transformation region(s) are identified at step 908. The functional region(s) for a molecule comprises either its identified transformation region(s) or the transformation region(s) and region(s) of interest. A region of interest comprises one of an immediate neighbourhood and an extended neighbourhood of the transformation region(s). The linker region(s) comprises region(s) remaining after the identified functional region(s). The identified functional region(s) and associated linker region(s) of the molecule(s) participating in the plurality of reactions are collected at step 910. The functional region(s) of the plurality of reactions, wherein the functional region(s) comprise the collected functional region(s) of the molecule(s) participating in the plurality of reactions, are selected at step 912. The linker region(s) of the plurality of reactions, wherein the linker region(s) comprise the collected linker region(s) of the molecule(s) participating in the plurality of reactions are selected at step 914. The plurality of reactions based on similarity of the functional regions along with associated information are grouped together to create the transformation library at step 916. Finally, functional region(s) for each group is/are derived from the functional region(s) of the reaction(s) comprising the group as representative functional region(s) at step 918. In one of the embodiments, the functional region derived is a maximum common region of functional regions across all the reactions within the group.

The associated information comprises a list of one or more enzymes catalysing the reaction(s) and the extracted functional region(s) and linker region(s) of the reaction(s). The similar chemical transformation is identified by matching up the one or more functional regions of the input reactions.

Therefore, the transformation library includes a plurality of groups of chemical reactions wherein each of the groups includes chemical reactions undergoing similar chemical transformations along with the list of enzyme(s) catalysing each of the reactions as well as the functional and linker region(s) of each of the reactions. Each group has representative functional region(s). The systematic arrangement of groups in the transformation library makes them useful in terms of group assignment and deriving metabolite similarity scores as explained previously in the disclosure.

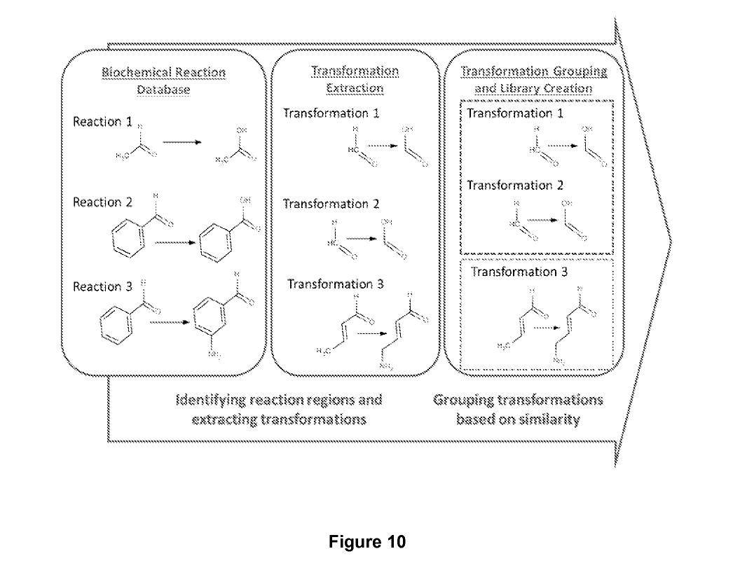

An embodiment of transformation grouping and transformation library creation is illustrated in FIG. 10. After obtaining various reactions from various biochemical databases as input, the reactions are split into their reactants and products and the molecule(s) undergoing transformation in each of the reactions is identified. Further, the transformation region(s) for each of the molecules participating in the reaction is/are identified and extracted. Based on the identified transformation region(s) the corresponding functional region(s) is/are identified. Once the functional region(s) is/are identified, the linker region(s) associated with the functional region(s) is/are identified and extracted. Subsequently, the functional region(s) of each of the input reactions is/are compared with the functional region(s) of other input reactions to find out similar reactions. Similar reactions are grouped together along with their functional and linker regions to constitute the transformation library.

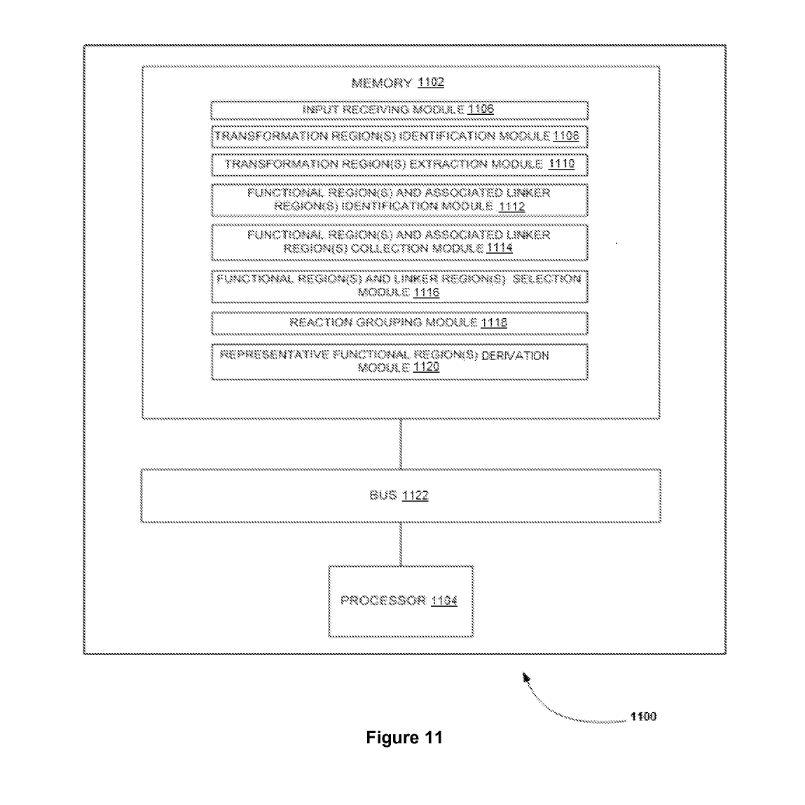

FIG. 11 is a block level diagram of a device for generating transformation library in accordance with an exemplary embodiment of the present disclosure. The device is configured to generate the transformation library.

The device 1100 includes processor(s) 1104, and memory 1102 coupled to the processor(s) 1104.

The processor(s) 1104, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 1102 includes a plurality of modules stored in the form of executable program code which instructs the processor 1104 to perform the method steps illustrated in FIG. 9. The memory 1102 includes the following modules: input receiving module 1106, transformation region(s) identification module 1108, transformation region(s) extraction module 1110, functional and linker region(s) identification module 1112, collection module 1114, functional and linker region(s) selection module 1116, reaction grouping module 1118, and representative functional region(s) derivation module 1120.

Computer memory elements may include any suitable memory device(s) for storing data and executable program code, such as read only memory, random access memory, erasable programmable read only memory, electrically erasable programmable read only memory, a hard drive, a removable media drive, e.g., for handling memory cards, and the like. Embodiments of the present disclosure may be implemented in conjunction with program modules, including functions, procedures, data structures, and application programs, for performing tasks, or defining abstract data types or low-level hardware contexts. Executable program stored on any of the above-mentioned storage media may be executable by the processor(s) 1104.

The input receiving module 1106 instructs the processor(s) 1104 to perform the step 902 (FIG. 9).

The transformation region(s) identification module 1108 instructs the processor(s) 1104 to perform the step 904 (FIG. 9).

The transformation region(s) extraction module 1110 instructs the processor(s) 1104 to perform the step 906 (FIG. 9).

The functional and linker region(s) identification module 1112 instructs the processor(s) 1104 to perform the step 908 (FIG. 9).

The functional region(s) and associated linker region(s) collection module 1114 instructs the processor(s) 1104 to perform the step 910 (FIG. 9).

The functional region(s) and linker region(s) selection module 1116 instructs the processor(s) 1104 to perform the steps 912 and 914 (FIG. 9).

The reaction grouping module 1118 instructs the processor(s) 1104 to perform the steps 916 (FIG. 9).

The representative functional region(s) derivation module 1120 instructs the processor(s) 1104 to perform the steps 918 (FIG. 9).

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium.

The present disclosure embodiments, by efficiently predicting a suitable enzyme for a particular reaction or molecule, facilitates the synthetic pathway design. This makes the introduction of non-native metabolites in the system more feasible by accurately suggesting enzymes capable of catalysing the same. This is useful in designing pathways which would yield the desired chemicals at commercially viable scale.

### PRESENT DISCLOSURE

### GLOSSARY OF TERMS AND DEFINITIONS

Enzymes: Enzymes are biomolecules which catalyse biochemical transformations.

EC Numbers: Enzyme Commission Numbers

Transformation: Bond rearrangements associated with biochemical/chemical reactions is termed a Transformation

Transformation region: Atoms undergoing either bond connectivity change or bond order change define a Transformation region

What is claimed is:

1. A computer implemented method of determining one or more enzymes for one or more biochemical transformations, comprising:
receiving, by a computing device, input data regarding at least one of one or more reactions and one or more target molecules along with data associated with information regarding chemical conversion;
determining, by the computing device, one or more functional regions and one or more linker regions in at least one of the one or more reactions and the one or more target molecules;
scanning, by the computing device, a transformation library for the determined one or more functional to find similar one or more functional regions within the transformation library;
assigning, by the computing device, at least one of the one or more reactions and the one or more target molecules to one or more groups of the transformation library showing high similarity to the one or more functional regions;
computing, by the computing device, a metabolite similarity score of at least one of the one or more reactions and the one or more target molecules with respect to one or more reactions of the one or more assigned groups; and
identifying, by the computing device, one or more enzymes associated with the one or more reactions of the one or more assigned groups having a high metabolite similarity score.

2. The method as claimed in claim 1, wherein determining the one or more functional regions and the one or more linker regions in the one or more reactions, comprises:
identifying one or more functional regions in the one or more molecules participating in the one or more reactions;
identifying one or more linker regions associated with the one or more functional regions of the one or more molecules participating in the one or more reactions;
collecting the identified one or more functional regions of the one or more molecules participating in the one or more reactions;
collecting the identified one or more linker regions associated with the one or more functional regions of the one or more molecules participating in the one or more reactions;
selecting the one or more functional regions of the one or more reactions, wherein the one or more functional regions comprise the collected one or more functional regions of the one or more molecules undergoing transformation in the one or more reactions; and
selecting the one or more linker regions of the one or more reactions, wherein the one or more linker regions comprise the collected one or more linker regions of the one or more molecules undergoing transformation in the one or more reactions.

3. The method as claimed in claim 2, wherein identifying the one or more functional regions and the one or more linker regions in the one or more molecules participating in the one or more reactions, comprises:
identifying one or more transformation regions in one or more molecules participating in the one or more reactions;
extracting the identified one or more transformation regions in the one or more molecules participating in the one or more reactions;
identifying one or more functional regions and one or more linker regions for the one or more molecules participating in the one or more reactions based on the extracted one or more transformation regions;
splitting the one or more molecules participating in the one or more reactions into the one or more functional regions and the one or more linker regions based on the identified one or more functional regions and the one or more linker regions.

4. The method as claimed in claim 2 wherein identifying the one or more functional regions in the one or more target molecules, comprises:
deriving one or more transformation regions for the one or more target molecules based on the data associated with information regarding chemical conversion;
extracting the derived one or more transformation regions for the one or more target molecules; and
identifying the one or more functional regions and the one or more linker regions in the one or more target molecules for the extracted one or more transformation regions; and
splitting the one or more target molecules into the one or more functional regions and the one or more linker regions based on the identified one or more functional regions and the one or more linker regions.

5. The method as claimed in claim 1, wherein the one or more functional regions of the one or more molecules participating in the one or more reactions comprise one of the transformation region and the transformation region along with one or more regions of interest.

6. The method as claimed in claim 4, wherein the one or more functional regions of the one or more target molecules comprise one of the transformation region and the transformation region along with one or more regions of interest.

7. The method as claimed in claim 1, wherein the one or more linker regions comprise one or more regions remaining after the identified one or more functional regions.

8. The method as claimed in claim 1, wherein the target molecule is one of a reactant and product.

9. The method as claimed in claim 1, wherein the transformation library comprises a plurality of groups of one or more reactions undergoing similar chemical transformations represented by one or more functional regions and associated information.

10. The method as claimed in claim 9, wherein the associated information comprises of a list of one or more enzymes catalysing the one or more reactions and the determined one or more functional regions and one or more linker regions of the one or more reactions.

11. The method as claimed in claim 1, wherein computing the metabolite similarity score comprises:
extracting the one or more functional regions and the one or more linker regions in at least one of the one or more reactions and the one or more target molecules;
matching the extracted one or more functional regions of at least one of the one or more reactions and the one or more target molecules with the one or more functional regions of the assigned one or more groups;
matching the extracted one or more linker regions of at least one of the one or more reactions and the one or more target molecules with the one more linker regions of the one or more reactions of the assigned one or more groups; and
computing a similarity score based on the matched one or more functional regions and the one or more linker regions.

12. The method as claimed in claim 1, further comprising statistically evaluating flexibility, by the computing device, of the identified one or more enzymes for the input of at least one of the one or more reactions and the one or more target molecules.

13. A device for determining one or more enzymes for one or more biochemical transformations, comprising:
a memory; and
one or more processors operatively coupled to the memory, the one or more processors are configured to perform the steps of:
receiving input data regarding at least one of one or more reactions and one or more target molecules along with data associated with information regarding chemical conversion;
determining one or more functional regions and one or more linker regions in at least one of the one or more reactions and the one or more target molecules;
scanning a transformation library for the determined one or more functional regions to find similar one or more functional regions within the transformation library;
assigning at least one of the one or more reactions and the one or more target molecules to one or more groups of the transformation library showing high similarity to the one or more functional regions;
computing a metabolite similarity score of at least one of the one or more reactions and one or more target molecules with respect to one or more reactions of the one or more assigned groups; and
identifying one or more enzymes associated with the one or more reactions of the one or more assigned groups having a high metabolite similarity score.

14. The device as claimed in claim 13, wherein the one or more processors are further configured to perform statistically evaluating flexibility of the identified one or more enzymes for the input of at least one of the one or more reactions and the one or more target molecules.

15. A computer implemented method of generating transformation library, comprises:
obtaining, by a computing device, data regarding a plurality of reactions and one or more enzymes catalysing the same from one or more knowledgebases as input;
identifying, by the computing device, one or more transformation regions in one or more molecules participating in the plurality of reactions;
extracting, by the computing device, the identified one or more transformation regions in the one or more molecules participating in the plurality of reactions;
identifying, by the computing device, one or more functional regions and one or more linker regions for the one or more molecules participating in the plurality of reactions based on the one or more extracted transformation regions;
collecting, by the computing device, the identified one or more functional regions and associated one or more linker regions of the one or more molecules participating in the plurality of reactions;
selecting, by the computing device, the one or more functional regions of the plurality of reactions, wherein the one or more functional regions comprise the collected one or more functional regions of the one or more molecules participating in the plurality of reactions;
selecting, by the computing device, the one or more linker regions of the plurality of reactions, wherein the one or more linker regions comprise the collected one or more linker regions of the one or more molecules participating in the plurality of reactions;
grouping, by the computing device, the plurality of reactions based on similarity of the one or more functional regions along with associated information; and
deriving, by the computing device, one or more functional regions for each group from the one or more functional regions of the one or more reactions comprising the group as a representative group of one or more functional regions.

16. The method as claimed in claim 15, wherein the associated information comprises a list of one or more enzymes catalysing the one or more reactions and the identified one or more functional regions and one or more linker regions of the one or more reactions.

17. The method as claimed in claim 15, wherein the one or more functional regions of the one or more molecules participating in the one or more reactions comprise one of the transformation region and the transformation region along with one or more regions of interest.

18. The method as claimed in claim 15, wherein the one or more linker regions comprise region remaining after the identified one or more functional regions.

19. A device for generating a transformation library, comprising:
a memory; and
one or more processors operatively coupled to the memory, the one or more processors are configured to perform the steps of:
obtaining data regarding a plurality of reactions and one or more enzymes catalysing the same from one or more knowledgebases as input;
identifying one or more transformation regions in one or more molecules participating in the plurality of reactions;
extracting data regarding the identified one or more transformation regions in the one or more molecules participating in the plurality of reactions;
identifying one or more functional regions and one or more linker regions for the one or more molecules participating in the plurality of reactions based on the extracted data regarding one or more transformation regions;
collecting the identified one or more functional regions and one or more linker regions of the one or more molecules participating in the plurality of reactions;
selecting the one or more functional regions of the plurality of reactions, wherein the one or more functional regions comprise the collected one or more functional regions of the one or more molecules participating in the plurality of reactions;
selecting the one or more linker regions of the plurality of reactions, wherein the one or more linker regions comprise the collected one or more linker regions of the one or more molecules participating in the plurality of reactions;
grouping the plurality of reactions based on similarity of the one or more functional regions along with associated information; and
deriving one or more functional regions for each group from the one or more functional regions of the one or more reactions comprising the group as a representative group of one or more functional regions.
